(19) United States
(12) Patent Application Publication
(10) Pub. No.: US 2013/0130623 A1
(43) Pub. Date: May 23, 2013

(54) PORTABLE COMMUNICATION EQUIPMENT, SYSTEM AND METHOD FOR COMMUNICATING BETWEEN A LOCAL TERMINAL AND A PLURALITY OF PORTABLE EQUIPMENT

(71) Applicants: Cedric Hozanne, Lorgies (FR); Benoit Courouble, Hem (FR)

(72) Inventors: Cedric Hozanne, Lorgies (FR); Benoit Courouble, Hem (FR)

(73) Assignee: NATURAL SECURITY, Lille (FR)

(21) Appl. No.: 13/699,089

(22) PCT Filed: May 19, 2011
(86) PCT No.: PCT/FR2011/051142

§ 371 Date: Feb. 4, 2013

(30) Foreign Application Priority Data
May 20, 2010 (FR) 1053937

(51) Int. Cl. H04W 4/00

(52) U.S. Cl. CPC H04W 4/008
USPC 455/41.2

(57) ABSTRACT

Portable equipment, a system and a method of communication between a local terminal and a plurality of portable equipment via contactless communication means is provided. Each item of equipment has a first storage medium for storing a plurality of applications, a first processing system for carrying out an application transaction with the local terminal, a second processing system distinct from the first processing system for carrying out at least one application function with the terminal, and a second storage medium, the second processing system being suitable for writing to the second storage medium data representative of the result of at least one application function and the first processing system being suitable for reading the data from the second storage medium so as to carry out at least one application transaction with the local terminal.

### BACKGROUND

The invention relates to the field of communication equipment, systems and methods. The invention relates more particularly to a portable communication equipment item, a system and a method for communication between a local terminal and a plurality of portable equipment items.

The international applications WO 2005/078647 and WO 2007/100709 describe a communication method implementing a portable equipment item and a local terminal for the contactless transfer of data. The portable equipment item comprises a storage means for storing data containing a biometric template, applications and contactless communication means for receiving and transmitting data. The portable equipment item also comprises processing means for making a comparison between the biometric model that it stores and a biometric sample acquired by a biometric sensor linked to the local terminal and received from communication means of the local terminal. The local terminal is arranged to complete the setting up of a transactional session with the portable equipment item, then select the application of the portable equipment item to be called, only if the biometric sample corresponds to the biometric model. The portable equipment item is arranged to transmit to the local terminal a result of the application called by the local terminal.

These methods make it possible to authenticate, for the local terminal, the bearer of the portable equipment item as legitimate holder of that equipment item, in order to access an application held by the portable equipment item, with an enhanced level of security for example compared to the purely declarative mode, and do so without the bearer having to manipulate the portable equipment item. In the current methods, the check on the authenticity of the bearer is carried out for each access to each of the applications.

A number of contactless communication interfaces are also known, to enable telecommunication between a portable equipment item and a local terminal. Non-exhaustive examples thereof include the proximity interfaces for near field communication (ISO 14443) or the local area network or personal (ISO 802.15.4), Zigbee or Bluetooth (ISO 802.15.3) or Ethernet (ISO 802.11x) or Wi-Fi (ISO 802.11.x) interfaces. Inevitably, the use of these networks is spreading and their coverage area is increasing.

In this context, it will be understood that as the coverage area of the local terminal extends and the usage of portable equipment items in contactless communication with the terminal spreads, interferential or conflict-oriented phenomena, as yet imperceptible or barely perceptible, due to the detection by the local terminal of a plurality of portable equipment items in its coverage area, are bound to increase. Among these phenomena, a bearer who has a plurality of portable equipment items detected in the coverage area of a local terminal can be considered as an example. The case of several bearers each having at least one portable equipment item and located in the coverage area of one and the same local terminal can also be considered. Furthermore, since the number of applications held in each portable equipment item is always increasing, a number of said portable equipment items may hold a number of applications suitable to be called by the local terminal.

In a partial response to the emergence of these phenomena, an application blocking on the local terminal was first proposed which involves processing only a single portable equipment item at a time.

Another solution was then proposed, described in the international application WO 2009/087311. This application teaches a contactless biometric authentication system and an associated method which resolve the problems linked to the detection by the local terminal of a plurality of portable equipment items within its coverage area, by communicating to each detected portable equipment item the biometric sample acquired, in order for each to be able to compare them to the biometric model that it stores, a transactional session being opened between the local terminal and only the portable equipment item or items that has/have obtained a result of positive authentication of the user. A sequencing of the application transaction is made possible by the method according to the international application WO 2009/087311, on completion of a step of selection of the portable equipment item to be used and of the applications of that portable equipment item compatible with the local terminal, that is to say downstream of or during a procedure to access said applications.

### SUMMARY OF THE INVENTION

The present invention, which is based on these original observations, proposes an application solution that makes it possible to overcome one or more of the drawbacks mentioned previously.

To this end, the invention proposes a portable equipment item for communicating with a local terminal, the portable equipment item being associated with a service provider and with a holder and being used by a user,

the portable equipment item comprising at least:
a first storage medium for storing at least a plurality of applications,
first processing means arranged to execute an application transaction with the local terminal, according to one application out of said plurality of applications, and
second contactless communication means arranged to contactlessly transmit data to the local terminal,

the portable equipment item being characterized in that it also comprises:
second processing means distinct from the first processing means and arranged to execute at least one application function with the local terminal, and
a second storage medium accessible only in write mode for the second processing means and only in read mode for the first processing means,

said second processing means being suitable for writing to the second storage medium data representative of the result of said at least one application function and the first processing means being suitable for reading these data on the second storage medium in order to execute at least one application transaction with the local terminal according to at least one application out of said plurality of applications.

The portable equipment item thus makes it possible to sequence application transactions executed by the first processing means with the terminal, collect the data necessary to these executions being delegated to the second processing means which store them on the second storage medium, and upstream of any procedure to access an application.

According to a particular feature, the equipment item also comprises contact-based communication means via which at least one application transaction with the local terminal is executed by the first processing means according to at least one application out of said plurality of applications.

The portable equipment item thus retains its normal use of contact-based communication with the local terminal.

The invention also relates to a communication system comprising a local terminal and a plurality of portable equipment items, each portable equipment item being associated with a service provider and with a holder and being used by a user,

the local terminal comprising at least:
a detector arranged to detect the portable equipment items located within a coverage area of the local terminal, and
first contactless communication means arranged to contactlessly transmit data to each portable equipment item,

each portable equipment item comprising at least:
a first storage medium for storing at least a plurality of applications,
first processing means arranged to execute an application transaction with the local terminal, according to one application out of said plurality of applications, and
second contactless communication means arranged to contactlessly transmit data to the local terminal,

said communication system being characterized in that each portable equipment item also comprises:
second processing means distinct from the first processing means and arranged to execute at least one application function with the local terminal, and
a second storage medium accessible only in write mode for the second processing means and only in read mode for the first processing means,

said second processing means being suitable for writing to the second storage medium data representative of the result of said at least one application function and the first processing means being suitable for reading these data on the second storage medium in order to execute at least one application transaction with the local terminal according to at least one application out of said plurality of applications.

The system thus makes it possible not only to manage the simultaneous presence of a plurality of portable equipment items in the coverage area of the local terminal, but also to sequence the application transactions executed by the first processing means with the terminal, by delegating to the second processing means the collection of the data necessary to their executions which are stored on the second storage medium, upstream of any procedure to access an application.

According to a particular feature, each portable equipment item also comprises contact-based communication means via which at least one application transaction with the local terminal is executed by the first processing means according to at least one application out of said plurality of applications.

The system thus makes it possible to retain the normal use of contact-based communication of each portable equipment item with the local terminal, the selection of the portable equipment item to be used to execute said at least one application transaction being executed de facto.

According to another particular feature, the first storage medium of each portable equipment item stores authentication data of the portable equipment item and of the associated service provider and a first application function consists in authenticating the portable equipment item for the local terminal, at least on the basis of the authentication data of the portable equipment item and of the associated service provider.

The system thus makes it possible to verify, for the local terminal, the authenticity and the integrity of each portable equipment item detected in its coverage area, upstream of any procedure to access any application out of the plurality of applications stored on the first storage medium of each portable equipment item.

According to another particular feature, the local terminal is suitable for opening a contactless communication channel between the local terminal and each authenticated portable equipment item.

The system thus makes it possible to not communicate with corrupted, counterfeit or rejected portable equipment items, upstream of any procedure to access any application out of the plurality of applications stored on the first storage medium of each portable equipment item.

According to another particular feature, the first storage medium of each portable equipment item stores a list of the plurality of applications that it stores and a second application function consists at least in contactlessly transmitting the list of the applications to the local terminal, the local terminal being arranged to select, from the portable equipment items with each of which it has opened a communication channel, the portable equipment items that have at least one application recognized by the local terminal.

Thus, it is certain that the portable equipment item which will be selected to proceed with at least one application transaction with the local terminal has at least one application recognized by the local terminal, upstream of any procedure to access any application out of the plurality of applications stored on the first storage medium of each portable equipment item.

According to another particular feature, the first storage medium of each portable equipment item stores a template representative of authentication data of the holder of the portable equipment item and a third application function consists in authenticating, for the local terminal, the user of this portable equipment item, at least on the basis of the authentication data of the holder of the portable equipment item.

The system thus makes it possible to communicate only with the portable equipment items, definitely authenticated, but also for which the user is authenticated as legitimate holder, and to do so upstream of any procedure to access any application out of the plurality of applications stored on the first storage medium of each portable equipment item.

According to another particular feature, the local terminal is suitable for opening a transactional session with each authenticated portable equipment item for which the user has been authenticated, giving the local terminal access to the application or to the applications held by each of said portable equipment items.

The system thus makes it possible to open a transactional session with at least one authenticated portable equipment item of the user who is himself authenticated. Once the transactional session is open with said portable equipment item or items, the second processing means of each of these portable equipment items can no longer serve any purpose and advantageously become transparent in order to authorize direct access for the local terminal to the application or applications held by the portable equipment item or items in a transactional session with the local terminal.

According to another particular feature, if the authenticated user carry a number of authenticated portable equipment items, the local terminal either prompts the user to select the portable equipment item to be used for the transaction, or the local terminal itself chooses the portable equipment item to be used for the transaction when it has the data necessary to take this decision.

The system thus makes it possible to select, if this has not already been done, the portable equipment item to be used out of the portable equipment items in a transactional session with the local terminal.

According to another particular feature, if the selected portable equipment item holds a number of applications recognized by the local terminal, either the local terminal prompts the user to select at least one application, or the local terminal itself chooses at least one application when it has the data to take this decision, said at least one selected application being executed by the first processing means which read the data written on the second storage medium by the second processing means in order to execute at least one application transaction with the local terminal during a transactional session according to said at least one selected application.

According to another particular feature, the second processing means are suitable for erasing the data written on the second storage medium when the communication with the local terminal is terminated or interrupted.

The system thus makes it possible to prevent the traceabilty of the user and to guarantee his or her anonymity.

The invention also relates to a communication method, implemented in a communication system comprising a local terminal and a plurality of portable equipment items, each portable equipment item being associated with a service provider and with a holder, and being used by a user,

the local terminal comprising at least:
a detector arranged to detect the portable equipment items located in a coverage area of the local terminal, and
first contactless communication means arranged to contactlessly transmit data to each portable equipment item,

each portable equipment item comprising at least:
a first storage medium for storing at least a plurality of applications,
first processing means arranged to execute an application transaction with the local terminal, according to one application out of said plurality of applications, and
second contactless communication means arranged to contactlessly transmit data to the local terminal,

said communication method being characterized in that it comprises at least:
a first step of executing at least one application function, each portable equipment item also comprising second processing means distinct from the first processing means and arranged to execute said at least one application function,
a step of writing data representative of the result of said at least one application function, each portable equipment item also comprising a second storage medium accessible only in write mode for the second processing means, so that the writing step is executed by the second processing means on the second storage medium, and
a step of reading data representative of the result of said at least one application function, the second storage medium being accessibly only in read mode for the first processing means, so that the reading step is executed by the first processing means on the second storage medium in order to execute at least one application transaction according to at least one application out of said plurality of applications.

According to a particular feature, each portable equipment item also comprising contact-based communication means, the method also comprises a second step of executing at least one application transaction with the local terminal, this step being executed by the first processing means via contact-based communication means according to at least one application out of said plurality of applications.

According to another particular feature, since the first storage medium of each portable equipment item also stores authentication data of the portable equipment item and of the associated service provider, the first execution step comprises a first substep of executing a first application function, this substep consisting in authenticating the portable equipment item for the terminal, at least on the basis of said authentication data of the portable equipment item and of the associated service provider.

According to another particular feature, the method comprises a step of opening a communication channel executed by the contactless local terminal between the local terminal and each authenticated portable equipment item.

According to another particular feature, the first storage medium of each portable equipment item also storing a list of the plurality of applications that it stores, the first execution step also comprises a second substep of executing a second application function, this substep consisting at least in contactlessly transmitting to the local terminal the list of the applications, the local terminal being arranged to select, from the portable equipment items with each of which it has opened a communication channel, only the portable equipment items that have at least one application recognized by the local terminal.

According to another particular feature, the first storage medium of each portable equipment item also storing a template representative of authentication data of the holder of the portable equipment item, the first execution step also comprises a third substep of executing a third application function, this substep consisting in authenticating, for the local terminal, the user of this portable equipment item, at least on the basis of the authentication data of the holder of the portable equipment item.

According to another particular feature, the method comprises a step of opening a transactional session executed by the local terminal with each authenticated portable equipment item for which the user has been authenticated, giving the local terminal access to the application or to the applications held by each of said portable equipment items.

According to another particular feature, if the authenticated user carries a number of authenticated portable equipment items, the method also comprises a step of selecting the portable equipment item to be used for the transaction, this step consisting either of a choice offered to the user by the local terminal, or of a choice made by the local terminal, itself, if it has sufficient data to take this decision.

According to another particular feature, if the selected portable equipment item holds a number of applications recognized by the local terminal, the method also comprises a step of selecting the application to be executed, this step consisting either of a choice offered to the user by the local terminal, or of a choice made by the local terminal, itself, if it has sufficient data to take this decision, said at least one selected application being executed by the first processing means which read the data written on the second storage medium by the second processing means in order to execute at least one application transaction with the local terminal according to said at least one selected application.

According to another particular feature, the method comprises a step of erasing the data written on the second storage medium by the second processing means when the communication method is terminated or interrupted.

### BRIEF DESCRIPTION OF THE DRAWINGS

Other features and advantages of the invention will become more clearly apparent from the description given below, by way of indication and in a nonlimiting manner, with reference to the appended drawings, in which:

FIG. 1 schematically represents the communication system according to the invention,

FIG. 2 schematically represents a portable equipment item as in FIG. 1, and

FIG. 3 represents a few steps of the communication method according to the invention.

### DETAILED DESCRIPTION OF THE PREFERRED EMBODIMENT(S)

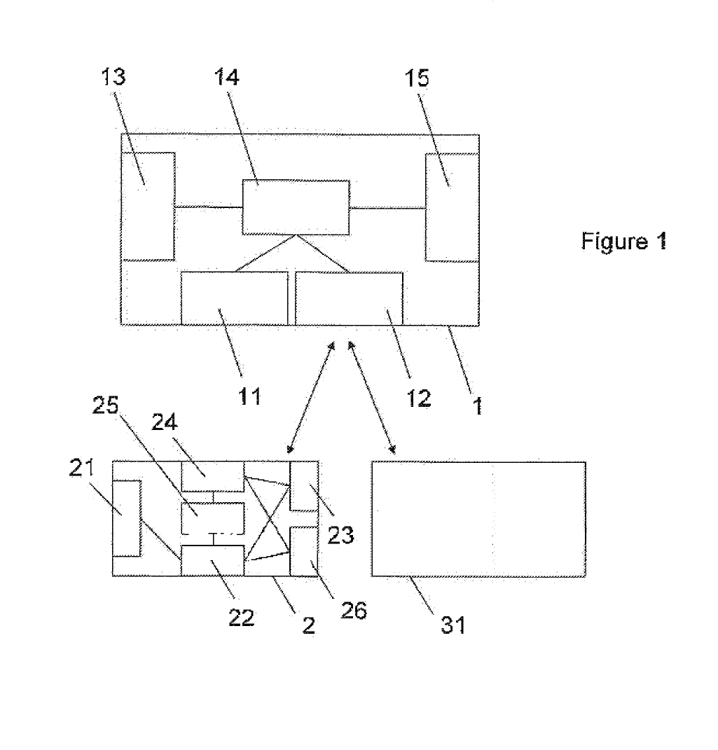

As illustrated in FIG. 1, the communication system according to the invention comprises a local terminal 1 and a plurality of portable equipment items 2 and 31. Each portable equipment item is associated with a service provider and with a holder, and is used by a user.

As nonlimiting examples, said service provider is a bank, an Internet and/or telephony access provider, a store chain or a public organization.

The local terminal 1 comprises at least:
a detector 11 arranged to detect the portable equipment items located in its coverage area,
first contactless communication means 12 arranged to contactlessly transmit between the local terminal and each portable equipment item data to each portable equipment item.

The local terminal 1 also comprises:
measurement means 13, such as a biometric reader, and
processing means 14.

In a first embodiment, the local terminal 1 is associated with a checkout system in a store such as a supermarket. In this example, the local terminal may also comprise:
a temporary storage memory,
an alphanumeric display,
a keypad,
a bill printer, and
software modules such as parameterizing and reporting alarms.

The checkout system, linked with the local terminal, may comprise in particular:
a human-machine interface with the checkout personnel,
a check printer,
a ticket printer,
an alphanumeric display,
a barcode scanner,
software modules for calculating the amount and for selecting the payment mode, and
a checkout keyboard.

The first contactless communication means 12 of the local terminal comprise a radiofrequency communication module based on at least one of the ISO standards mentioned in the introduction, and more particularly on the standard ISO 802.15.4. It should be noted that, for the latter, the frequency used is an ultra-high frequency in the 2.4 GHz band. Such a frequency is well suited for low-consumption contactless communications over distances less than 10 meters, and more particularly between 50 centimeters and 3 meters. Furthermore, the first contactless communication means 12 of the local terminal incorporate an anti-collision algorithm so that the local terminal can communicate with each detected portable equipment item when a plurality of portable equipment items is located in its coverage area. The system thus makes it possible to manage the simultaneous presence of a plurality of portable equipment items in the coverage area of the local terminal. The standard 802.15.4 makes it possible to have in the same area up to 65536 different equipment items. Another advantage with the use of the standard 802.15.4 is that this standard is particularly resistant to disturbance due to the use of other standards in the same 2.4 GHz frequency range.

In the first embodiment, the measurement means comprising the biometric reader are suitable for acquiring a biometric image of a user, for example an image of the vein network of a finger or of the hand of the user.

The processing means 14 of the local terminal comprise one or more microcontrollers or microprocessors or processors.

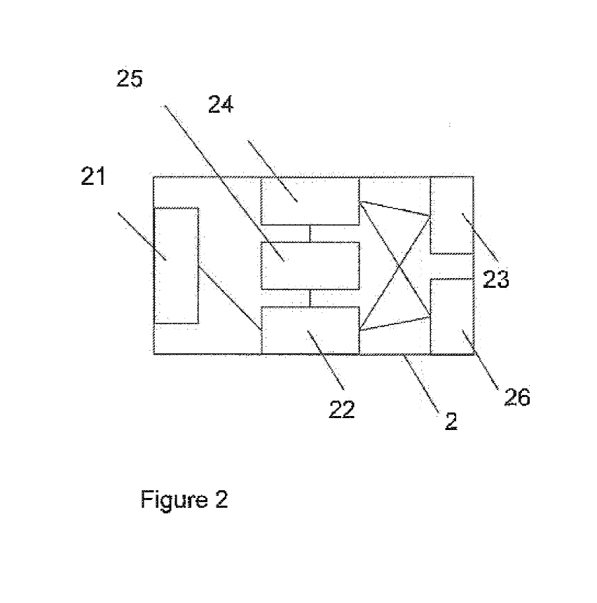

As illustrated in FIG. 2, each portable equipment item 2 comprises at least:
a first storage medium 21,
first processing means 22,
second contactless communication means 23,
second processing means 24, and
a second storage medium 25.

Among the portable equipment items 2, we can cite the equipment items in the following formats: bank card, electronic purse, equipment item embedding a SIM (Subscriber Identification Module) card, or an SD (Secure Digital), xD, MMC (Multimedia Memory Card), USB (Universal Serial Bus), PCMCIA (Personal Computer Memory Card International Association) memory card, and other such cards.

The first storage medium 21 of each portable equipment item corresponds, for example, to an EEPROM memory. It stores at least a plurality of applications. It also stores a list of said applications, a template representative of authentication data of the holder of the portable equipment item, authentication data of the portable equipment item, for example an MAC address, and authentication data of the service provider associated with the portable equipment item, for example a certificate of the service provider of the portable equipment item.

The first processing means 22 of each portable equipment item are arranged to execute an application transaction with the local terminal during a transactional session.

The contactless communication means 23 of each portable equipment item are arranged to contactlessly transmit between this portable equipment item and the local terminal data to the local terminal. They comprise at least a radiofrequency communication module based on at least one of the ISO standards mentioned in the introduction, and more particularly on the ISO 802.15.4 standard.

For each portable equipment item, the template representative of authentication data of the holder, the MAC address and the certificate of the service provider are stored on the first storage medium of this portable equipment item during the act of purchase or of renewing thereof. As for the plurality of applications held by each portable equipment item, it may well have been stored on the first storage medium during the act of purchase or of a renewal of the portable equipment item, as well as have been (down)loaded and/or enriched subsequent to the act of purchase or of renewal by the user or the service provider personnel. The corresponding list of applications is updated by the first or second processing means each time applications are added, deleted or updated.

It is important to note that the second processing means 24 of each portable equipment item are distinct from the first processing means 22, this feature and its advantages being discussed below.

Said second processing means 24 of each portable equipment item make it possible to execute at least one application function with the local terminal.

Said second storage medium is accessible only in write mode for the second processing means, during a writing step 7.

The second storage medium is also accessible only in read mode for the first processing means, during a reading step 9. The second storage medium corresponds, for example, to an SRAM or DRAM memory.

The second processing means are thus suitable for writing on the second storage medium data representative of the result of said at least one application function and the first processing means are suitable for reading these data on the second storage medium to execute at least one application transaction with the local terminal according to at least one application out of said plurality of applications.

The system thus makes it possible to collect, for each portable equipment item and upstream of any procedure to access an application, the data necessary to the execution of at least one application out of the plurality of applications. In practice, these data are collected as the result of at least one application function executed by the second processing means. They are made available to the first processing means on the second storage medium. Thus, a number of application transactions with the local terminal can be executed consecutively by benefiting from the collected data. The sequencing of the application transactions with the terminal is therefore made possible.

Furthermore, the execution of each application can have associated with it a required security level, corresponding for example to the need or not to collect such or such data. Thus, the execution of a first high-level security application may make it possible to execute at least one second application of the same or lower security level, for example without even the need for a new reading step 9. In practice, said at least one second application is executed without the need for additional checks simply because of the prior execution of the first application.

The portable equipment item also comprises contact-based communication means 26, for example a contact interface of chip card type, and/or a battery for powering its communication means and its first and second processing means. The battery can possibly be recharged during a contact of the contact interface with the chip card reader linked to the local terminal. The system thus makes it possible to retain the standard use of contact-based communication of each portable equipment item with the local terminal. In the case where the contact-based communication means of a portable equipment item are required, the second processing means retain their role of data collector to enable the first processing means to benefit therefrom, so as to allow for the sequencing of the applications. However, the use of the contact-based communication means 26 means that the selection of the portable equipment item to be used to execute said at least one application transaction is executed de facto, the execution of at least one application transaction with the terminal via the contact-based communication means taking priority over the execution of at least one application transaction with the terminal via the second contactless communication means of the same portable equipment item or of any other portable equipment item.

Since the first storage medium 21 of each portable equipment item stores authentication data of the portable equipment item and of the associated service provider, a first application function consists in authenticating the portable equipment item for the local terminal, at least on the basis of the authentication data of the portable equipment item and of the associated service provider. The system thus makes it possible to verify, for the local terminal, the authenticity and the integrity of each portable equipment item detected in its coverage area. The algorithm implemented for the authentication of the portable equipment item is a static authentication mechanism (SDA, or “Static Data Authentication”) or a dynamic authentication mechanism (DDA, or “Dynamic Data Authentication”).

It should be noted that, in addition to the authentication of each portable equipment item for the local terminal, it is perfectly possible to envisage authenticating the local terminal for each portable equipment item.

In the first embodiment, the local terminal is arranged to open a contactless communication channel only with each portable equipment item that has been authenticated, during a step of opening a communication channel 6.

The system thus makes it possible to not communicate with corrupted, counterfeit or rejected portable equipment items. The authentication for the terminal of each portable equipment item out of the plurality of portable equipment items detected in its coverage area therefore constitutes a first selection of portable equipment items out of the plurality of portable equipment items detected by the detector of the local terminal.

The system comprises means for securing each open communication channel between the local terminal and each authenticated portable equipment item, for example using certificates of PKI type, public keys and private keys. An exchange of public keys takes place between the local terminal and each of the authenticated portable equipment items. All the portable equipment items and the local terminal therefore have in memory a private key/public key pair which is specific to them, in order to be able to open a secure communication channel between each authenticated portable equipment item and the local terminal.

In the first embodiment, the first communication means 12 of the local terminal are arranged to contactlessly transmit a request to each portable equipment item with which it has opened a communication channel. Said request requests the transmission by each portable equipment item concerned of the list of the applications that it holds. The second processing means of each portable equipment item are arranged to contactlessly transmit the list of applications to the local terminal via the second contactless communication means 23, in response to said request. The processing means of the local terminal are arranged to select from the plurality of portable equipment items with each of which it has opened a communication channel only the portable equipment items that have at least one application recognized by the local terminal. Thus, it is certain that the single portable equipment item which will be selected to proceed with an application transaction has at least one application recognized by the local terminal.

It is essential to add here that the local terminal may also know the application that it wants to execute, and consequently keep, out of the plurality of portable equipment items with each of which it has opened a communication channel, only the portable equipment items that hold this determined application.

In the first embodiment, the local terminal associated with the checkout system is dedicated to the payments for purchases made by the user. The local terminal then selects the portable equipment items with which it can execute the payment of the purchases, that is to say, the portable equipment items that have at least one payment application. Furthermore, the local terminal can accept the payment for the purchases for example with payment cards supplied by the company “A” or the company “B”, but not with payment cards supplied by the company “C”. In this case, the local terminal keeps the communication channel open only with the payment cards supplied by the companies “A” and “B” and closes the communication channel or channels, or remains mute, with the payment card or cards supplied by the company “C”.

In the first embodiment, the second processing means 24 of each authenticated portable equipment item make it possible to authenticate the user of this authenticated portable equipment item for the local terminal.

To do this, the measurement means 13 of the local terminal are arranged to acquire authentication information from the user and the processing means 14 of the local terminal are arranged to generate corresponding authentication data. The latter are transmitted by the first communication means 12 of the contactless local terminal via each communication channel to each authenticated portable equipment item. Then, the second processing means 24 of each authenticated portable equipment item compare the authentication data transmitted by the local terminal with the template that it stores and generate, in case of a positive comparison, positive authentication data. Then, the contactless communication means 23 of each authenticated portable equipment item for which the user has been authenticated contactlessly transmit the positive authentication data to the local terminal.

In the first embodiment, the EEPROM memory of each portable equipment item comprises a number of templates representative of authentication data of the holder of the portable equipment item, these templates being adapted to the information likely to be generated by the usual measurement means. In particular, if the measurement means of the local terminal comprise a biometric reader to acquire an image of the vein network of one of the fingers of the user, the EEPROM memory of each portable equipment item must comprise at least the template of the image of the vein network of each finger of the user. Furthermore, the second processing means of each portable equipment item are arranged to compare this template to the image picked up by the measurement means of the local terminal and transmitted to the portable equipment item by the first contactless communication means. More particularly, the template is representative of authentication data of the holder which can correspond to a condensate of a biometric image, this condensate being obtained for example from a hashing function determined at the level of the service provider and applied to a biometric image. On its side, the local terminal can use its processing means to apply a hashing function identical to the one applied at the level of the service provider, so as to no longer compare the biometric images, but only the condensates obtained from these images. If necessary, said hashing function may be determined by the local terminal using the MAC address of the mobile equipment item and/or the certificate of the service provider.

The local terminal opens a contactless transactional session only with each authenticated portable equipment item for which the user has been authenticated, during a transactional session opening step 8. This step gives the local terminal access to the application or to the applications held by each of said portable equipment items. Thus, the local terminal directly accesses the application or applications held by each of said portable equipment items.

The system thus makes it possible to authenticate the user of the portable equipment item as legitimate holder of the portable equipment item(s) that he or she carries and to open a transactional session only with the authenticated portable equipment item(s) of the authenticated user, upstream of any process to access an application. Once the transactional session is open with said portable equipment items(s), the second processing means 24 of each of these portable equipment items no longer serve any purpose and advantageously become transparent for the first processing means which take over to execute a procedure to access at least one application. This access procedure consists in authorizing the direct access for the local terminal to the application or applications held by the portable equipment item(s) in transactional session with the local terminal, on the basis of the data previously written by the second processing means on the second storage medium. The feature of transparency of the second processing means of each portable equipment item is made possible by the fact that the first and second processing means of each portable equipment item are distinct from one another.

In one embodiment, the second processing means comprise means for interrupting and/or starting up first processing means at least to coordinate the access to the second storage medium in write mode for the second processing means or in read mode for the first processing means. These interruption and/or startup means consist of a semaphore, a monitor or a synchronization barrier, for example consisting of two semaphores, and one variable, for example stored on the second storage medium. These interruption and/or startup means are arranged so as to interrupt the second processing means and start up the first processing means, when the second processing means have accomplished the tasks, or said at least one application function, for which it is responsible, the variable being a flag or the number of tasks which fall to the second processing means. In a variant, the first processing means also comprise means for interrupting and/or starting up second processing means. These interruption and/or startup means can be arranged so as to interrupt the first processing means and start up the second processing means, when the first processing means have accomplished the tasks, or said at least one application transaction, for which they are responsible, so that, for example, the second processing means erase the data that they have previously written on the second storage medium.

If the contact-based communication means of a portable equipment item are used, the terminal opens a transactional session by contact with this portable equipment item. As stated previously, the selection of the portable equipment item is executed de facto, a single transactional session being opened. However, there may remain the need to select at least one application out of the plurality of applications stored on the first storage medium of said portable equipment item.

If the authenticated user carry a number of authenticated portable equipment items each having at least one application recognized by the local terminal, either the local terminal itself chooses the equipment item when it has data to take this decision, or the local terminal prompts the user to select the portable equipment item to be used for the transaction (via, by way of example, a personalized label in each portable equipment item).

The system according to the invention thus makes it possible to select the single portable equipment item to be used out of the portable equipment item or items in contactless transactional session with the local terminal.

In the first embodiment, the user may have been authenticated as legitimate holder of a payment card supplied by the company “A” and of a payment card supplied by the company “B”. The local terminal can then refer to a priority rule to determine with which of these two payment cards to execute the payment. Said priority rule may be defined in different ways. For example, it may be defined internally to the local terminal or defined jointly with the list of the applications stored by each of the two cards. If the priority rule does not exist or does not allow for a choice, the local terminal prompts the user via the checkout system to select the payment card that he or she wants to use. This choice offered to the user is provided for example by a display on the alphanumeric screen or on a touch screen of the checkout system. In practice, the touch screen may be arranged to be seen by the user or the checkout personnel and to display an image representing the two cards, the user or the checkout personnel pressing on the representation of the payment card to be used.

If the selected portable equipment item holds a number of application recognized by the local terminal, either the local terminal itself chooses at least one application to be executed when it has data to take this decision, or the local terminal prompts the user to select at least one application to be executed. Said at least one selected application is executed by the first processing means 22 of the selected portable equipment item in order to execute an application transaction with the local terminal during one and the same transactional session.

In the first embodiment, some payment cards offer either a cash payment or a deferred payment. The system makes it possible to proceed as in the example described above to choose between a cash payment or a deferred payment. The idea is to submit the choice to the user only as a last resort so that the system is as transparent as possible to the user.

In the first embodiment, the system also comprises an electronic banking and services subsystem to perform the payment transactions, and more generally, any service transaction. This subsystem manages in particular the relationship with the bank server. The electronic banking and services subsystem consists of software components that are run on the cards and on the local terminal. It executes in particular the functions of authorizing or rejecting payments, of implementing the payment transaction and, more generally, of implementing service transactions. If it is a service transaction, then the way the transaction runs is specific to the service concerned.

As disclosed above, by virtue of the communication equipment item, the system and the communication method between a local terminal and a plurality of portable equipment items according to the invention, it is possible to sequence a number of application transactions during one and the same transactional session, after at least one reading step 9.

For example, a payment may be followed by a loyalty transaction, the data necessarily collected for the execution of the payment offering a high level of security possibly authorizing, by the same token, a loyalty transaction of a less strict security level. If the service transaction cannot be carried out to its conclusion, the possibility of reverting to the initial state preceding the transaction is envisaged.

Thus, one advantage of the system is that it does not require, once the single portable equipment item of a user is selected, any authentication to allow for the execution of the application transaction the authentication of said portable equipment item and the authentication of its user having already been executed once for all the application transactions to be executed during one and the same transactional session.

Thus, the method according to the invention comprises a first step of executing at least one application function.

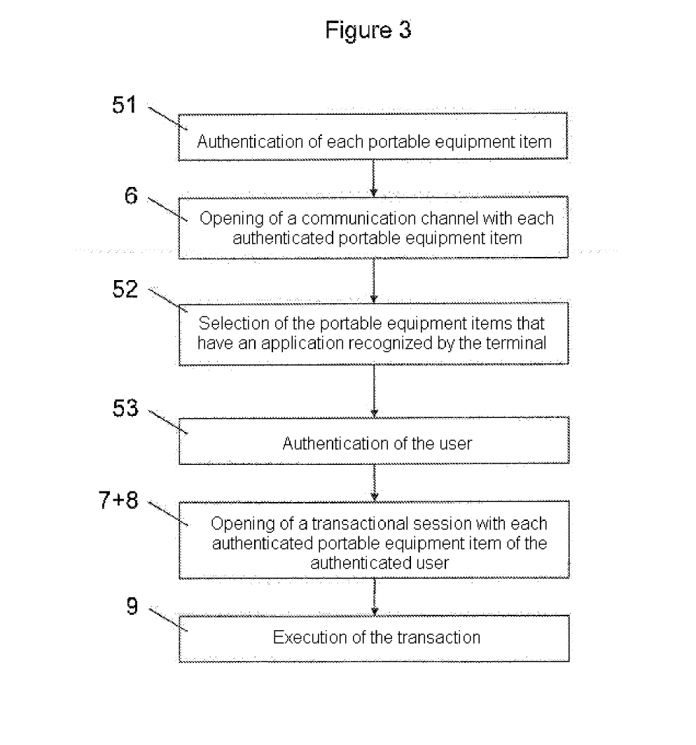

As illustrated in FIG. 3, the first execution step consists at least of:
a first substep 51 of executing a first application function, this substep consisting in authenticating the portable equipment item for the terminal, at least on the basis of authentication data of the portable equipment item and of the associated service provider,
a second substep 52 of executing a second application function, this substep consisting at least in contactlessly transmitting to the local terminal the list of the applications, the local terminal being arranged to select, from the portable equipment items with each of which it has opened a communication channel, only the portable equipment items that have applications recognized by the local terminal,
a third substep 53 of executing a third application function, this substep consisting in authenticating, for the local terminal, the user of this portable equipment item, at least on the basis of the authentication data of the holder of the portable equipment item.

It should be noted that the writing step 7 is executed at least between the first execution step 5 and the step of opening a transactional session 8. More particularly, the writing step 7 can be executed after each execution substep in order to write the data resulting from each execution substep or after the last execution substep in order to write just once the data resulting from all the execution substeps.

It should be noted that the first and second processing means of each portable equipment item do not serve the same purpose, the first executing with the local terminal at least one application out of the plurality of applications stored on the first storage medium and the second executing at least one application function to collect the data necessary to the execution of at least one application out of the plurality of applications stored on the first storage medium. This feature justifies the fact that said first and second processing means can be different from one another, because the processing capacities that each of said first and second processing means need to have depend on the tasks that each of them has to accomplish, the tasks which fall to the first processing means being different from the tasks which fall to the second processing means. It should be noted that the role played by the first processing means of each portable equipment item is not for all that, limited to simply the step of executing at least one transaction according to at least one application.

The method also comprises a step of erasing the data written on the second storage medium by the second processing means when the communication method is terminated or interrupted. The system and the method thus make it possible to prevent any traceability of the user and to guarantee his or her anonymity.

It should be noted that a portable equipment item with which the local terminal no longer communicates because that portable equipment item does not hold any application recognized by the local terminal may legitimately belong to the authenticated user.

The system and the method offer the advantage of adapting automatically to all the cases of use. They also offer the advantage of requiring only a slight and inexpensive modification of the known communication systems. This modification relates essentially to the portable equipment items at their application but above all hardware, level. This modification effectively consists of the addition of said second processing means and of said second storage medium to the known portable equipment items. This addition can, furthermore, be carried out regardless of the portable equipment item, even if the latter does not allow for contactless communication, whether with the local terminal or another equipment item. In other words, this addition can be made directly at the level of the design of the processing means intended to equip all the types of portable equipment items. This advantage devolves from the fact that said second processing means are arranged to be transparent during a transactional session. Thus, adding them to the first processing means with which all the portable equipment items are already equipped does not presuppose their systematic use. For example, in the standard case of a contact-based application transaction between the portable equipment item and the local terminal, the first processing means of the portable equipment item may suffice to complete the execution of an application transaction, the second processing means remaining transparent.

It should be noted that, while it is a payment transaction that has been considered in the first embodiment of the invention, the communication system and method are in no way limited to this particular transaction.

It should be obvious to the persons skilled in the art that the present invention allows for embodiments in many other specific forms without departing from the scope of application of the invention as claimed. Consequently, the present embodiments should be considered by way of illustration but may be modified in the field defined by the scope of the attached claims.

1-22. (canceled)

23. A portable equipment item for communicating with a local terminal, the portable equipment item being associated with a service provider and with a holder and being used by a user,
the portable equipment item comprising:
a first storage medium for storing at least a plurality of applications,
first processing means arranged to execute an application transaction with the local terminal, according to one application out of said plurality of applications, and
second contactless communication means arranged to contactlessly transmit data to the local terminal,
second processing means distinct from the first processing means and arranged to execute at least one application function with the local terminal, and
a second storage medium accessible only in write mode for the second processing means and only in read mode for the first processing means,
said second processing means being suitable for writing to the second storage medium data representative of a result of said at least one application function and the first processing means being suitable for reading the data on the second storage medium in order to execute at least one application transaction with the local terminal according to at least one second application out of said plurality of applications.

24. The portable communication equipment item as claimed in claim 23, further comprising contact-based communication means via which at least one application transaction with the local terminal is executed by the first processing means according to at least one application of said plurality of applications.

25. A communication system comprising a local terminal and a plurality of portable equipment items, each said portable equipment item being associated with a service provider and with a holder and being used by a user, the local terminal comprising:
a detector arranged to detect the portable equipment items located within a coverage area of the local terminal, and first contactless communication means arranged to contactlessly transmit data to each said portable equipment item,
each said portable equipment item comprising:
a first storage medium for storing at least a plurality of applications,
first processing means arranged to execute an application transaction with the local terminal, according to one application of said plurality of applications, and
second contactless communication means arranged to contactlessly transmit data to the local terminal,
second processing means distinct from the first processing means and arranged to execute at least one application function with the local terminal, and
a second storage medium accessible only in write mode for the second processing means and only in read mode for the first processing means,
said second processing means being suitable for writing to the second storage medium data representative of the result of said at least one application function and the first processing means being suitable for reading the data on the second storage medium in order to execute at least one application transaction with the local terminal according to at least one application out of said plurality of applications.

26. The communication system as claimed in claim 25, wherein each said portable equipment item also comprises contact-based communication means via which at least one application transaction with the local terminal is executed by the first processing means according to at least one application of said plurality of applications.

27. The communication system as claimed in claim 25, wherein the first storage medium of each said portable equipment item stores authentication data of the portable equipment item and of the associated service provider and a first application function consists in authenticating the portable equipment item for the local terminal, at least on the basis of the authentication data of the portable equipment item and of the associated service provider.

28. The communication system as claimed in claim 25, wherein the local terminal is suitable for opening a contactless communication channel between the local terminal and each said authenticated portable equipment item.

29. The communication system as claimed in claims 25, wherein the first storage medium of each said portable equipment item stores a list of the plurality of applications that is stored and a second application function consists at least in contactlessly transmitting the list of the applications to the local terminal, the local terminal being arranged to select, from the portable equipment items with each of which the local terminal has opened a communication channel, the portable equipment items having at least one application recognized by the local terminal.

30. The communication system as claimed in claim 25, wherein the first storage medium of each said portable equipment item stores a template representative of authentication data of the holder of the portable equipment item and a third application function consists in authenticating, for the local terminal, the user of said portable equipment item, at least on the basis of the authentication data of the holder of the portable equipment item.

31. The communication system as claimed in claim 30, wherein the local terminal is suitable for opening a transactional session with each authenticated portable equipment item for which the user has been authenticated, giving the local terminal access to the application or to the applications held by each of said portable equipment items.

32. The communication system as claimed in claim 31, wherein, if the authenticated user carry a number of authenticated portable equipment items, the local terminal (1) either prompts the user to select the portable equipment item to be used for the transaction, or the local terminal itself chooses the portable equipment item to be used for the transaction when it has the data to take this decision.

33. The communication system as claimed in claim 32, wherein if the selected portable equipment item holds a number of applications recognized by the local terminal, either the local terminal prompts the user to select at least one application, or the local terminal itself chooses at least one application when the local terminal has the data to take this decision, said at least one selected application being executed by the first processing means which read the data written on the second storage medium by the second processing means in order to execute at least one application transaction with the local terminal according to said at least one selected application.

34. The communication system as claimed in claim 25, wherein the second processing means are suitable for erasing the data written on the second storage medium when the communication with the local terminal is terminated or interrupted.

35. A communication method, implemented in a communication system comprising a local terminal and a plurality of portable equipment items, each said portable equipment item being associated with a service provider and with a holder, and being used by a user, which local terminal comprises:
a detector arranged to detect the portable equipment items located in a coverage area of the local terminal, and
first contactless communication means arranged to contactlessly transmit data to each portable equipment item,
each said portable equipment item comprising:
a first storage medium for storing at least a plurality of applications,
first processing means arranged to execute an application transaction with the local terminal, according to one application out of said plurality of applications, and
second contactless communication means arranged to contactlessly transmit data to the local terminal,
said communication method comprising:
a first step of executing at least one application function, each portable equipment item also comprising second processing means distinct from the first processing means and arranged to execute said at least one application function,
a step of writing data representative of the result of said at least one application function, each said portable equipment item also comprising a second storage medium accessible only in write mode for the second processing means, so that the writing step is executed by the second processing means on the second storage medium, and
a step of reading data representative of the result of said at least one application function, the second storage medium being accessible only in read mode for the first processing means, so that the reading step is executed by the first processing means on the second storage medium in order to execute at least one application transaction according to at least one application out of said plurality of applications.

36. The communication method as claimed in claim 35, wherein each portable equipment item also comprises contact-based communication means, and the method further comprises a second step of executing at least one application transaction with the local terminal, this step being executed by the first processing means via the contact-based communication means and according to at least one application out of said plurality of applications.

37. The communication method as claimed in claim 35, wherein the first execution step comprises a first substep of executing a first application function, this substep consisting of authenticating the portable equipment item for the terminal, at least on the basis of authentication data of the portable equipment item and of the associated service provider, these data being stored on the first storage medium of each portable equipment item.

38. The communication method as claimed in claim 37, further comprising a step of opening a communication channel executed by the contactless local terminal between the local terminal and each authenticated portable equipment item.

39. The communication method as claimed in claim 38, further comprising the first storage medium of each portable equipment item also storing a list of the plurality of applications that is stored, the first execution step further comprises a second substep of executing a second application function, said second substep consisting at least in contactlessly transmitting to the local terminal the list of the applications, the local terminal being arranged to select, from the portable equipment items with each of which it has opened a communication channel, only the portable equipment items that have applications recognized by the local terminal.

40. The communication method as claimed in claim 39, further comprising the first storage medium of each portable equipment item also storing a template representative of authentication data of the holder of the portable equipment item, the first execution step also comprising a third substep of executing a third application function, said third substep consisting in authenticating, for the local terminal, the user of this portable equipment item, at least on the basis of the authentication data of the holder of the portable equipment item.

41. The communication method as claimed in claim 40, further comprising a step of opening a transactional session executed by the local terminal with each authenticated portable equipment item for which the user has been authenticated, giving the local terminal access to the application or to the applications held by each of said portable equipment items.

42. The communication method as claimed in claim 41, further comprising if the authenticated user carries a number of authenticated portable equipment items, a step of selecting the portable equipment item to be used for the transaction, said step consisting either of a choice offered to the user by the local terminal, or of a choice made by the local terminal, itself, if it has data to take this decision.

43. The communication method as claimed in claim 42, further comprising if the selected portable equipment item holds a number of applications recognized by the local terminal, a step of selecting at least one application, this step consisting either of a choice offered to the user by the local terminal, or of a choice made by the local terminal, itself, if the local terminal has data to take this decision, said at least one selected application being executed by the first processing means which read the data written on the second storage medium by the second processing means in order to execute at least one application transaction with the local terminal according to said at least one selected application.

44. The communication method as claimed in claim 35, further comprising a step of erasing the data written on the second storage medium by the second processing means when the communication method is terminated or interrupted.
